(19) United States
(12) Patent Application Publication
(10) Pub. No.: US 2009/0079140 A1
(43) Pub. Date: Mar. 26, 2009

(54) Device for sealing sensor and sensor element

(75) Inventors: Roland Achhammer, Beratzhausen (DE); Rudolf Bierl, Regensburg (DE); Jan-Erik Hauschel, Apolda (DE); Stefan Pesahl, Saal A. D. Donau (DE); Manfred Schweimeier, Kammeltal/Ettenbeuren (DE); Frank Steuber, Bad Abbach (DE); Andreas Wildgen, Nittendorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens VDO Automotive AG, Regensburg (DE)

(21) Appl. No.: 11/921,121

(22) PCT Filed: May 19, 2006
(86) PCT No.: PCT/EP2006/062450

§ 371 Date: Nov. 27, 2007

(30) Foreign Application Priority Data
May 27, 2005 (DE) 102005024384.3

(51) Int. Cl. F16J 15/04; F16J 15/06

(52) U.S. Cl. 277/602; 277/626; 277/627

(57) ABSTRACT

An air mass sensor arrangement is disclosed. The air mass sensor arrangement includes a duct having a recess and an outer face; a sensor comprising a main body and a baseplate extending radially outward from the main body, the sensor being releasably attached to the duct by a screw connection so that the main body is partially inserted into the recess and the baseplate faces the outer face; and a sealing arrangement disposed around the recess for sealing between the duct and the sensor. The sealing arrangement includes a first web formed on one of the baseplate and the outer face and completely surrounding the recess.

The present invention relates to a device for sealing a sensor and to a sensor element, only air mass sensors having been considered below, without any restriction to use with regard to general sensors.

According to the prior art, an air mass sensor is a small-build component which has low weight and which is installed, directly downstream of an air filter, in an intake duct of a motor vehicle. Here, the air mass sensor measures the air mass flow to the engine with high accuracy. Values measured by the air mass sensor form the basis for determining a gasoline injection quantity in spark ignition engines. In diesel engines, an exhaust gas recirculation quantity and a maximum injection quantity are calculated from the measurement values of an air mass sensor. On account of their reliable functioning and their robustness with respect to environmental influences, air mass sensors thus contribute most appreciably to a reduction of pollutant emissions in internal combustion engines.

In a known way, air mass sensors are introduced in what is known as a “plug-in” type of construction into a recess in the intake duct to a depth of approximately 40 mm, with an accuracy of alignment with the longitudinal axis of the intake duct of approximately +/−1°, and are fixed releasably on the outside of the intake duct by means of screw connections. In this case, gap sealing, which is to avoid an ingress of unfiltered raw air, is required around the respective recess. The leaktightness of this seal has to be maintained over the lifetime of the motor vehicle or of the air mass sensor. Moreover, via the seal, there has to be tolerance compensation between the assembly partners. This gives rise to highly diverse requirements in a sealing material requiring permanent resistance to various media over a broad temperature range and a large number of temperature changes, on the one hand, and a possibility for the provision of mechanical compensation, on the other hand. Moreover, the aim is to have a cost-effective solution for gap seals, even though a measurement accuracy of air mass sensors depends most essentially on the reliability of the associated gap seals.

Seals are known from the prior art which are implemented in the recess by means of O-rings consisting of elastomers. Alternatively, complicated profile seals are used for sealing, these profile seals usually being produced as injection moldings. In the abovementioned solutions, for sufficient tolerance compensation, a very high mechanical prestress is required for creating correspondingly good sealing, such prestress having against it a material hardness necessary for the high temperature range and long lifetime of the sealing material and also the brittle material of the assembly partners. The second-mentioned solution involves relatively costly special parts.

The object of the present invention, therefore, is to provide a device for sealing a sensor, having good mechanical tolerance compensation, a long lifetime and costs which are lowered, as compared with known devices, and also a corresponding sensor element. This object is achieved by means of the features of the respective independent claims.

According to the invention, a device for sealing a sensor, which is arranged so as to engage through a recess into a duct and is fixed releasably to the duct, is distinguished in that a sealing region with at least one sealing arrangement is provided outside the recess, the sealing arrangement being designed for sealing around the recess. Since, according to the invention, in contrast to known sealing measures in the recess itself, sealing is now shifted into a region outside the actual recess, tolerance problems can be solved more easily. In addition, in this case, influences of high temperature fluctuations on a respective seal are mitigated.

Advantageous developments form the subject matter of subclaims. Accordingly, the sealing arrangement is designed for sealing between a baseplate of a sensor housing of the sensor and an outer face of the duct. Consequently, in contrast to devices on releasably fixed sensor connections, there are even no sealing measures provided in and on the recess itself.

Furthermore, in one embodiment of the invention, the recognition that a seal can be produced particularly cost-effectively as a flat seal is adopted. In this case, a tubular elastomer is divided in disk form. No Shore hardnesses of below approximately 60 Sh can be employed on account of production. Even flat seals of this type require very high mechanical prestress in the main force flux or secondary force flux for tolerance compensation. When materials in said Shore hardness range are used, such prestress cannot be implemented by means of self-cutting metal screws, used regularly for the installation of sensors, in the glass fiber-reinforced plastic material, for example PBT-GF30 used for the intake duct and the sensor housing, or sufficient leaktightness cannot be maintained for the lifetime of a motor vehicle in the case of frequent temperatures changes over the temperature range which is customary when a motor vehicle is operation. Instead of an O-ring or a flat seal being pressed in, flat, between two assembly partners in the form of the outer wall of the intake duct and a sensor baseplate covering the recess, according to this embodiment of the invention a flat seal is placed as a sealing arrangement between two webs arranged so as to be offset with respect to one another.

In each case a web arranged so as to run continuously around the recess is attached to the sealing face of the two assembly partners in such a way that the seal is deformed itself when the two components are assembled together.

In particular, the inside and the outside of the usually annularly designed seal are deflected contradirectionally to one another. For this purpose, a flat seal is placed in each case between webs arranged so as to be offset with respect to one another on an outer wall of the intake duct and on a recess-covering baseplate of the housing of the sensor. The webs are formed in the manner of a wall around the recess in the intake pipe. Elastic deformation occurs in this case, which provides a prestressing of the sealing material between the assembly partners. Permanent sealing consequently takes place between the two webs.

In an alternative embodiment of the invention, a contactless seal in the form of a labyrinth is provided as a sealing arrangement in a region around the recess. By virtue of this measure, a pressure loss due to the formation of a possible flow path in the form of a labyrinth is increased to an extent such that the fraction of the air which penetrates through the labyrinth becomes negligibly low. Since the assembly partners involved, the outer wall of the intake duct and/or the recess-covering baseplate of the housing of the sensor, are at least one glass fiber-reinforced plastic part, it is also possible comparatively simply to provide more complicated contours in the region around the recess on the outer wall of the intake duct and on the recess-covering baseplate of the housing of the sensor. This more complicated contour consists of at least one combination which is formed from a groove and a web engaging into the groove under conditions of use.

Preferably, the structural measures contributing to sealing are implemented in one step, together with the overall shaping of the respective plastic parts, preferably within the framework of a plastic injection molding process. Since, even with a labyrinth seal being used, the molds still do not necessarily have undercuts, the construction of a corresponding injection mold and a removal of the finished plastic parts from the mold are possible in a relatively simple way.

In a further alternative embodiment of the invention, at least one closed web is provided as a sealing arrangement in the region around the recess and is provided on the baseplate of the sensor housing so as to be oriented with the outer wall of the intake duct and/or on the outer wall of the intake duct, in the region around the recess, so as to be oriented with the baseplate of the sensor housing, said baseplate covering the recess in the installation position of the sensor. During the screwing together of the assembly partners, that is to say of the baseplate of the housing of the sensor together with the tubular intake duct, the at least one web is deformed by pressing between the assembly partners, that is to say the baseplate and the sensor housing, on the one hand, and the region of the outer wall of the intake duct around the recess, on the other hand, to an extent such that sufficient leaktightness, even without the use of additional sealing material, can be achieved.

The first exemplary embodiment is distinguished by the advantage that flat seals of high Shore hardness can be adopted and, moreover, high component tolerances can be compensated. The two last-mentioned embodiments of the invention achieve high permanent leaktightness due to contactless sealing with a labyrinth structure and due to pinching during the fixing of the sensor in the recess. For this purpose, in these exemplary embodiments, the manufacturing step for inserting a seal and a sealing material in the form of a separate component is also saved.

Advantageously, all three exemplary embodiments mentioned may be provided jointly, combined in pairs or all together with one another in any possible sequence, for sealing a sensor component in a region around a recess of a duct.

Further advantages of a device according to the invention and of a correspondingly designed sensor component are described in more detail below, with reference to illustrations of exemplary embodiments, by means of the drawing in which, in a diagrammatic illustration:

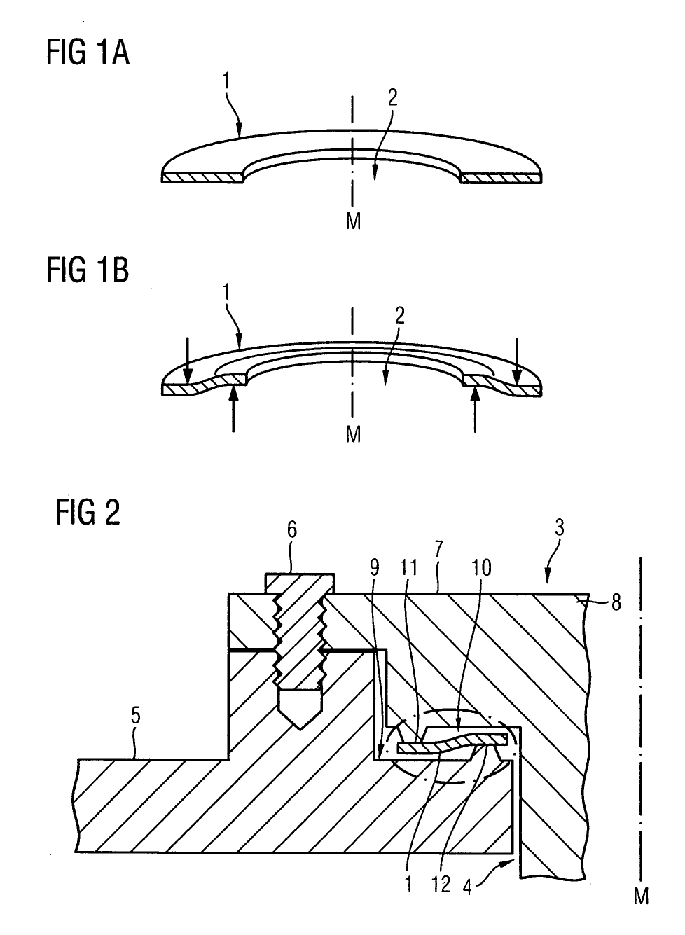

FIG. 1a shows a sectional illustration of a flat seal in a normal state;

FIG. 1b shows a sectional illustration of the flat seal according to FIG. 1a in a state installed according to the invention, with an indication of the forces acting on the flat seal for the deformation of two regions spaced tangentially apart from one another;

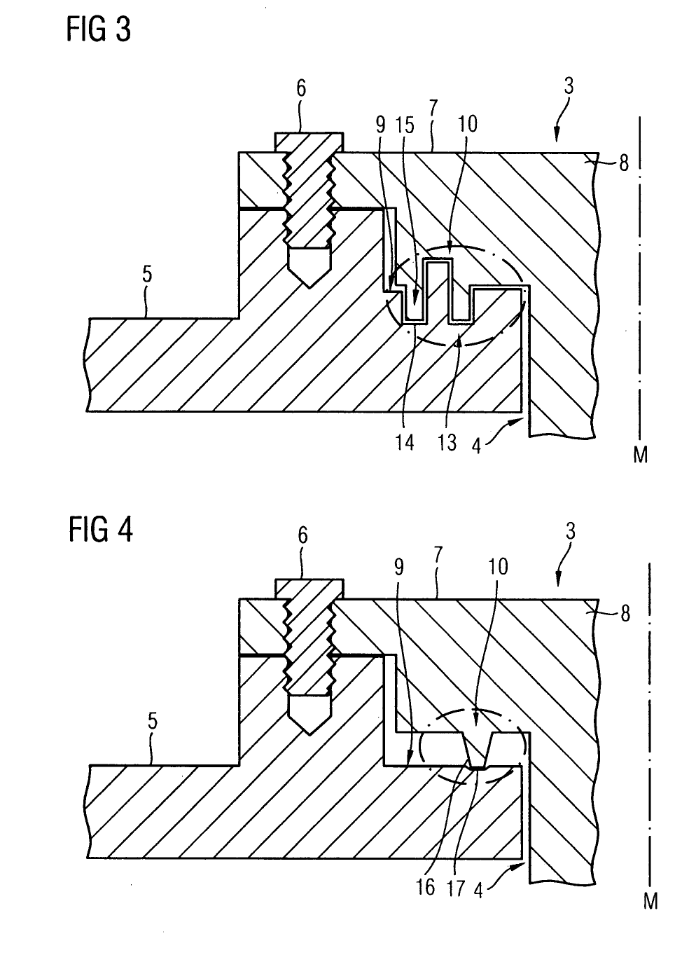

FIG. 2 shows a sectional illustration of a recess on a tubular body with a sensor mounted therein, with a web arrangement on the two assembly partners and with an intermediate flat seal, as a first embodiment of the present invention;

FIG. 3 shows a sectional illustration of the tube recess according to FIG. 2 with a sensor element mounted therein, with sealing by means of a contactless labyrinth structure, as a second embodiment of the present invention;

FIG. 4 shows a sectional illustration of the tube recess according to FIGS. 2 and 3 with a sensor element mounted therein, using a sealing arrangement with pressing of material, as a third embodiment;

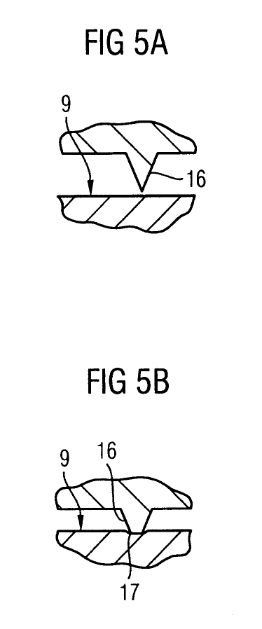

FIG. 5a shows, as a detail, an illustration of a pressing region according to the embodiment of FIG. 4, before the assembly partners are assembled, and

FIG. 5b shows the detail of FIG. 5a after the assembly partners have been assembled, with the sensor element fixed to the tube.

The same reference symbols are used below for identical elements throughout the various embodiments. The present exemplary embodiments are illustrated for circular or elliptically designed sealing regions which are preferred because of their better properties with regard to tolerance compensation. In view of the fact that an alignment of sensor elements with a main flow direction of an airstream must take place with an accuracy of +/−1° for optimal operation of the sensor element, however, square recesses are also implemented in pipes or ducts. In this case, the sealing arrangements described below in detail may be implemented in an adapted way and, in particular, also in a square embodiment.

FIG. 1a shows a known flat seal 1 in a normal state. Flat seals 1 of this type, because of their cost-effective production, are employed preferably as seals in a broad sector of industry. For production, a tubular elastomer is divided into disks of predetermined height. However, no Shore hardnesses of below 60 Sh can be adopted on account of production. Flat seals 1 of this type require very high prestressing for sufficient tolerance compensation, specifically irrespective of their use in a main force flux or secondary force flux. In use between the housing part of a sensor element and an outer wall of an intake duct, the required forces cannot be implemented and/or they cannot be maintained over the broad range of temperatures occurring during use for the entire lifetime of a motor vehicle in the event of frequent temperature changes. A substantial reason for this is that the two assembly partners are produced from a glass fiber-reinforced plastic material and are connected to one another by means of self-cutting metal screws.

Instead of an O-ring or a flat seal according to FIG. 1a being pressed in between the two assembly partners, in a first embodiment of the invention the flat seal 1 is placed between two webs which are arranged so as to be offset with respect to one another and face one another and which are provided on the assembly partners. The size of the webs is in this case selected such that one of the webs completely surrounds the other, without intersection points between the webs occurring.

In the present exemplary embodiment, therefore, each of the sealing faces of the two assembly partners has in each case a closed web running continuously around the recess 2. The flat seal 1 is in this case deformed, when the two assembly partners are assembled, in a way illustrated in FIG. 1b. For this purpose, an inner region and an outer region of the annular flat seal 1 are deflected contradirectionally to one another in the way illustrated in FIG. 1b. In this case, elastic deformation occurs, which provides a prestress of the rubber ring or of the flat seal 1 between the two assembly partners. The flat seal 1 thus generates a seal which takes effect between the two webs. This seal is distinguished, as compared with a normally customary pressing of a flat seal 1, in that a substantially lower force is required for deflecting an inner region with respect to an outer region. As a result, even in the event of a compensation of relatively high component tolerances, a sealing action which is always sufficient can be established in structural terms.

FIG. 2 shows the flat seal 1 of FIGS. 1a and 1b in a sectional illustration of a new installation situation.

The arrangement of FIG. 2 is symmetrical to a center axis M, and therefore an illustration of the second half of the arrangement is dispensed with. A sensor 3 is inserted through a recess 4 of a tubularly designed intake duct 5 and is fixed to an outer face 9 of the intake duct 5 by means of a screw connection 6 of a baseplate 7 of a sensor body 8. In contrast to solutions known from the prior art, a sealing region 10 is arranged between the screw connection 6 and the recess 4. In this sealing region 10, the flat seal 1 is arranged, the recess 2 of which is larger than or substantially equal to the diameter of the recess 4 in the intake duct 5.

In the embodiment of FIG. 2, an outer region of the flat seal 1 is deflected by a web 11 in the sealing region 10, the web 11 being integrally formed on the baseplate 7 of the sensor body 8 of the sensor 3. The inner region of the flat seal 1 is deflected, contradirectionally to the deformation of the flat seal 1 caused by the web 11, by a web 12 which is formed adjacently to the recess 4 in the sealing region 10 on the intake duct 5. Consequently, between the webs 11, 12, a good sealing action is generated as a result of the deformation of the flat seal 1, which also has a degree of tolerance with respect to dimensional deviations of the assembly partners, that is to say, here, the baseplate 7 and the intake duct 5, in the sealing region 10 near the recess 4.

In a further exemplary embodiment, according to FIG. 3, in an overall set-up similar to FIG. 2, the sealing region 10 is formed by a contactless seal in the form of a labyrinth 13. In the present exemplary embodiment, three successive pairs of a groove 14 and of a web 15 in each case are provided, which in the sealing region 10 have alternately a web 15 on the baseplate 7 and the outer wall 9. In the present instance, therefore, two grooves and one web are formed in the intake duct 5 and two webs and one groove are formed in the baseplate 7, undercuts not occurring in any of these cross-sectional shapes in the respective interfaces.

To form the labyrinth, pairs of grooves 14 and webs 15 arranged concentrically to the center axis M are formed, between which, in the assembled state of the assembly partners, intake duct 5 and baseplate 7, a very narrow passage duct, which can be seen in FIG. 3, with numerous bends and turns of the resulting labyrinth is generated in the sealing region 10. The high leaktightness achievable, without any wear on the two assembly partners when they are assembled or during operation, can advantageously be implemented very efficiently by means of comparatively simple injection molding dies for the processing of glass fiber-reinforced plastic, such as, for example, PBT-GF30.

A third exemplary embodiment is disclosed in FIG. 4, again with reference to the general structure according to FIG. 2 and FIG. 3. In this, the sealing region 10 is likewise produced without additional sealing material, using directed pressing. For this purpose, the baseplate 7 has a web which is aligned with the outer wall 9 of the intake duct 5 and which is closed around, with a spacing from the recess 5, and, in general, projects with a free shape from the baseplate 7.

During assembly, with the sensor 3 being fixed to the baseplate 7 of the sensor body 8 by means of a screw connection 6 via the recess 4, the web 16 is pressed into the material of the intake duct 5. As a result, the web 16, approximately triangular in cross section before pressing, according to FIG. 5a, is deformed essentially in cross section into a type of trapezium. In this case, a trough 17 is formed beneath the web 16 in the outer wall 9 of the intake duct 5. On account of the elasticity of the plastic material provided on the intake duct 5 and the baseplate 7, there is very close contact between the web 16 and the trough 17, thus bringing about good sealing which, in turn, makes the use of additional sealing material unnecessary.

A comparison of FIGS. 3 and 4 already makes it clear that the sealing measures illustrated above with reference to FIGS. 2 to 4 may be implemented by being combined with one another in a small additionally required construction space for a sealing region 10 around the recess 4. In this case, the benefits of the respective types of seal are advantageously added up. As a result, a device which reliably seals permanently for the lifetime of a motor vehicle is provided, while, particularly with reference to the third embodiment according to FIG. 4, a sensor element 3 can be used directly around a recess 4 on an intake pipe 5 without any structural change of a sealing region 10.

1.-10. (canceled)

11. An air mass sensor arrangement comprising:
a duct having a recess and an outer face;
a sensor comprising a main body and a baseplate extending radially outward from the main body, the sensor being releasably attached to the duct by a screw connection so that the main body is partially inserted into the recess and the baseplate faces the outer face; and
a sealing arrangement disposed around the recess for sealing a region between the baseplate and the outer face, the sealing arrangement comprising a first web formed on one of the baseplate and the outer face and completely surrounding the recess.

12. The air mass sensor arrangement of claim 11, wherein the sealing arrangement further comprises a second web formed on the other of the baseplate and the outer face and radially offset from the first web, and a flat seal, the flat seal comprising a first portion supported by the first web, and a second portion supported by the second web so that the first portion is axially offset from the second portion.

13. The air mass sensor arrangement of claim 12, wherein at least one of the first web and the second web is trapezoidal, rectangular or semicircular shaped.

14. The air mass sensor arrangement of claim 11, wherein the sealing arrangement comprises a contactless labyrinth seal.

15. The air mass sensor arrangement of claim 11, wherein the sealing arrangement comprises a groove formed on the other of the baseplate and the outer face, the first web extending into the groove.

16. The air mass sensor arrangement of claim 14, wherein the contactless labyrinth seal comprises two grooves formed on the other of the baseplate and the outer face, and a second web formed on the one of the baseplate and the outer face, the first and second webs extending into the respective grooves, the contactless labyrinth seal being concentrical to a central axis of the recess.

17. The air mass sensor arrangement of claim 11, wherein the first web is pressed against the other of the baseplate and the outer face to form a seal.

18. The air mass sensor arrangement of claim 11, wherein at least one of the main body, the baseplate and the duct comprises a glass fiber-reinforced plastic material.
